(19) United States
(12) Patent Application Publication
(10) Pub. No.: US 2016/0063006 A1
(43) Pub. Date: Mar. 3, 2016

(54) AUTO-COMPLETE SUGGESTIONS FOR STRUCTURED SEARCHES

(71) Applicant: GOOGLE INC., Mountain View, CA (US)

(72) Inventors: Stanislav Belogolov, Zurich (CH); David Nachum, San Francisco, CA (US); Julio Gerchman, Zurich (CH)

(21) Appl. No.: 14/472,334

(22) Filed: Aug. 28, 2014

(51) Int. Cl. G06F 17/30; H04L 29/08; H04L 12/58

(52) U.S. Cl. CPC G06F 17/3064; G06F 17/30011; H04L 51/22; G06F 17/30657; H04L 67/10

(57) ABSTRACT

A method is provided for offering auto-complete suggestions to structured search queries. The method is performed at a server system and includes receiving, from a client device, a partial search query that includes one or more search terms. The method further includes analyzing the one or more search terms of the partial search query to determine one or more auto-complete suggestions. At least one of the one or more auto-complete suggestions includes a respective predefined search operator distinct from the one or more search terms chosen from a plurality of predefined search operators based on a result of the analysis of the one or more search terms of the partial search query. The method further includes formatting, for concurrent display with the partial search query at the client device, the at least one of the one or more auto-complete suggestions that includes a predefined search operator.

### TECHNICAL FIELD

The disclosed implementations relate to methods, server systems, and computer readable storage media for providing auto-complete suggestions to structured searches (also called “structured queries”).

### BACKGROUND

As the informational world has grown in size and become more connected, methods of searching for information have become ubiquitous and essential. To be sure, the wealth of information available on the Internet (including electronic mail and other personal communications) is far less useful if the desired information is difficult to find. Some searches are known as content-based searches. In an example of a typical content-based search, a user will enter a search query such as “cheesecake recipe” to look for documents, e.g., on the Internet, that have content related to cheesecake recipes.

In contrast, in a structured search, the user will indicate that the search results have certain properties, for example, by specifying attribute-value pairs for the search results. As a more specific example, a user might specify that he is interested in searching for electronic mail (emails) that were sent prior to Nov. 30, 2013. Thus, matching search results will have an attribute (e.g., a “sent date” attribute) and a value, or range of values, corresponding to that attribute (e.g., all dates and times prior to Nov. 30, 2013). The specification of the attribute-value pair can be entered, for example, by the user through a graphical user interface (GUI), through a particular syntax of a textual search query, or a combination thereof. In addition, searches need not be purely content-based or purely structured. On the contrary, many searches are a combination of both types.

Conventional methods of structured searches are inconvenient for users. For example, GUI-based entry of structured search queries is impractical when there are a large number of potential attributes for which to specify a value or property. To provide buttons for each attribute would simply take up too much space on an electronic device's display. On the other hand, textual entry of structured queries requires a computer-savvy user because the user has to remember all of the various syntaxes through which to specify particular properties of the desired search results.

### SUMMARY

Accordingly, there is a need for accurate systems and methods of entering structured searches that are convenient for users regardless of their level of competence with computers. Therefore, in accordance with some implementations, methods, systems, and computer-readable storage media are proposed for providing auto-complete suggestions to users for search queries that include potential structured search terms.

In some implementations, a method is performed at a server system. The method includes receiving, from a client device, a partial search query that includes one or more search terms. The method further includes analyzing the one or more search terms of the partial search query to determine one or more auto-complete suggestions. At least one of the one or more auto-complete suggestions includes a respective predefined search operator distinct from the one or more search terms chosen from a plurality of predefined search operators based on a result of the analysis of the one or more search terms of the partial search query. The method further includes formatting, for concurrent display with the partial search query at the client device, the at least one of the one or more auto-complete suggestions that includes a predefined search operator.

In some implementations, the analysis of the partial search query is performed prior to execution of a search corresponding to the partial search query.

In some implementations, analyzing the one or more search terms includes determining that the one or more search terms are expressed in a respective format of a plurality of formats corresponding to the respective predefined search operator. Moreover, a determination that the one or more search terms are expressed in any of the plurality of formats corresponding to the respective predefined search operator is sufficient to result in an auto-complete suggestion that includes the respective predefined search operator.

In some implementations, analyzing the one or more search terms includes determining that the one or more search terms include one or more content indicia corresponding to the respective predefined search operator.

In some implementations, formatting, for concurrent display with the partial search query at the client device, the at least one of the one or more auto-complete suggestions includes formatting the at least one of the one or more auto-complete suggestions to display a predefined system format corresponding to the respective predefined search operator. Display of the predefined system format includes display of information corresponding to the one or more search terms displayed in accordance with the predefined system format.

In some implementations, the predefined system format includes a plurality of fields and the one or more search terms include information corresponding to a value of a respective field of the plurality of fields. In some implementations, formatting the at least one of the one or more auto-complete suggestions to display the predefined system format includes formatting for display in accordance with the predefined system format: (i) the information corresponding to the value of the respective field and (ii) visual indicia corresponding to incomplete values for each of the plurality of fields for which information is not specified by the one or more search terms.

In some implementations, the method further includes sending instructions to the client device to guide a user through entry of incomplete values for each of the plurality of fields for which information is not specified by the one or more search terms.

In some implementations, the method further includes receiving a user input selecting the at least one of the one or more auto-complete suggestions and searching a plurality of electronic documents in accordance with the at least one of the one or more auto-complete suggestions.

In some implementations, the plurality of electronic documents is a plurality of electronic messages corresponding to a user of the client device.

In some implementations, a respective electronic document in the plurality of electronic documents is labeled with a label. The respective predefined search operator is for returning electronic documents labeled with the label. In some implementations, the label is one of a user-defined label or a system-defined label.

In some implementations, the predefined search operator is a Boolean operator.

In some implementations, the predefined search operator specifies a logical ordering of two or more other predefined search operators.

In another aspect of the present invention, to address the aforementioned limitations of structured searching, some implementations provide a non-transitory computer readable storage medium storing one or more programs. The one or more programs comprise instructions, which when executed by a server system with one or more processors and memory, cause the server system to perform any of the methods provided herein.

In yet another aspect of the present invention, to address the aforementioned limitations of structured searching, some implementations provide a server system. The server system includes one or more processors, memory, and one or more programs. The one or more programs are stored in memory and configured to be executed by the one or more processors. The one or more programs include an operating system and instructions that when executed by the one or more processors cause the server system to perform any of the methods provided herein.

### BRIEF DESCRIPTION OF THE DRAWINGS

FIG. 1 is a diagram of a client-server environment, in accordance with some implementations.

FIG. 2 is a block diagram illustrating an example of a server system, discussed above with reference to FIG. 1, in accordance with some implementations.

FIGS. 3A-3D illustrate examples of graphical user interfaces (GUIs) that provide auto-complete suggestions for structured search queries, in accordance with some implementations.

FIGS. 4A-4C illustrate additional examples of graphical user interfaces (GUIs) that provide auto-complete suggestions for structured search queries, in accordance with some implementations.

FIGS. 5A-5B illustrate still additional examples of graphical user interfaces (GUIs) that provide auto-complete suggestions for structured search queries, in accordance with some implementations.

FIGS. 6A-6B illustrate still additional examples of graphical user interfaces (GUIs) that provide auto-complete suggestions for structured search queries, in accordance with some implementations.

FIGS. 7A-7C illustrate a flowchart of a method for providing auto-complete suggestions for structured searching, in accordance with some implementations.

Like reference numerals refer to corresponding parts throughout the drawings.

### DESCRIPTION OF IMPLEMENTATIONS

Structured searches are tremendously powerful. Rather than merely searching for and identifying informational items (e.g., web pages, electronic documents, and email messages) by their content, structured searches allow users to look for informational items that have certain properties and/or attributes. Such properties and/or attributes are often stored as metadata. However, structured searches can also be difficult for users, especially novices. The implementations provided herein help users enter structured search queries by providing auto-complete suggestions that include search operators corresponding to particular properties and/or attributes that might be of interest to the user.

Consider, as an example, a situation in which a user is using a search function of her webmail to search for particular emails. When the user begins to enter text that is recognizable as relating to a dates and/or times into the search query, in some implementations, the user is provided with auto-complete suggestions that include search operators that relate to date and time. Thus, the user is guided through the process of refining her search query to request a search for, e.g., emails that were sent prior to a particular date and time.

Reference will now be made in detail to various implementations, examples of which are illustrated in the accompanying drawings. In the following detailed description, numerous specific details are set forth in order to provide a thorough understanding of the present disclosure and the described implementations herein. However, implementations described herein may be practiced without these specific details. In other instances, well-known methods, procedures, components, and mechanical apparatus have not been described in detail so as not to unnecessarily obscure aspects of the implementations.

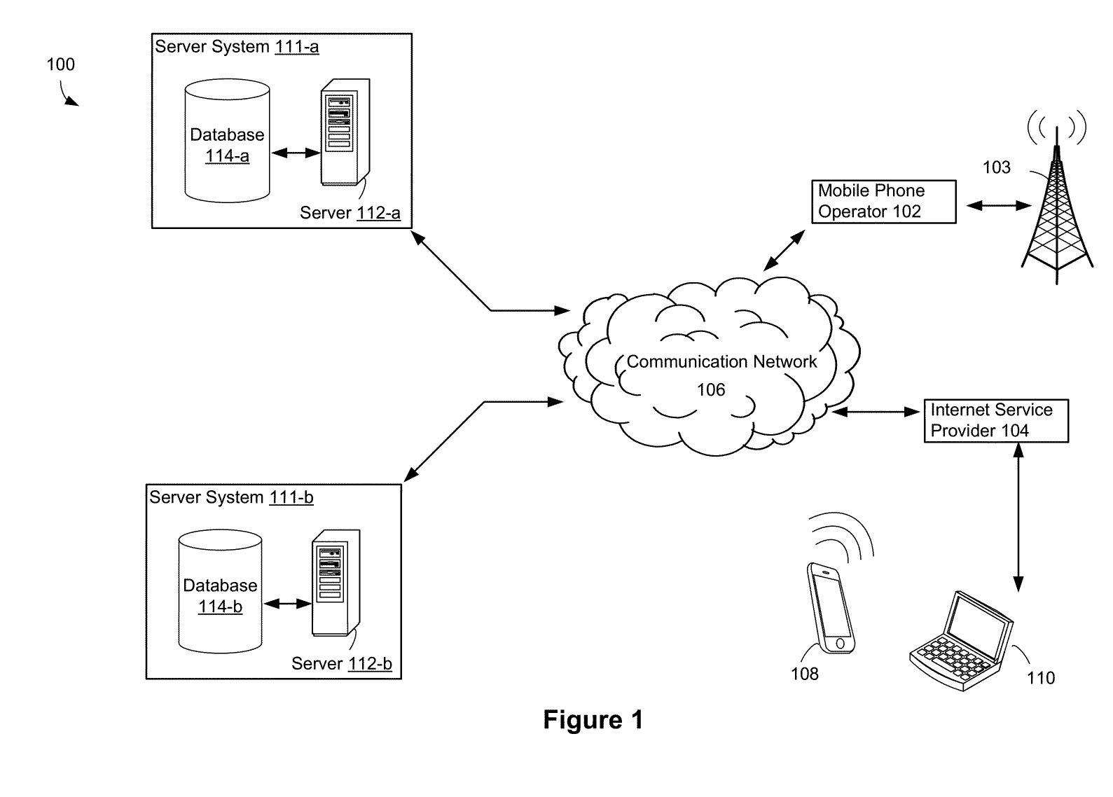

FIG. 1 is a diagram of client-server environment 100, in accordance with some implementations. While certain specific features are illustrated, those skilled in the art will appreciate from the present disclosure that various other features have not been illustrated for the sake of brevity and so as not to obscure more pertinent aspects of the implementations disclosed herein. To that end, client-server environment 100 includes server system 111-a, which stores electronic documents (e.g., emails) in database 114-a, provides auto-complete suggestions for structured search queries and performs searches for the electronic documents based on the structured search queries (as well as other tasks) using server 112-a. In some implementations, database 114-a is part of a distributed database 114 that also includes database 114-b of server system 111-b. Likewise, in some implementations, processing tasks are distributed between server 112-a and 112-b (as well as other servers). As used herein, the term “client” is intended to, in some circumstances, include servers, e.g., when said servers are accessing services that are made available by another server, and therefore are acting as clients.

Client-server environment 100 further includes one or more mobile phone operators 102, one or more Internet service providers 104, and a communications network 106.

Mobile phone operator 102 (i.e., a wireless carrier), and Internet service provider 104 are capable of being connected to communication network 106 in order to exchange information with one another and/or other devices and systems. Additionally, mobile phone operator 102 and Internet service provider 104 are operable to connect client devices to communication network 106 as well. For example, smart phone 108 is operable with the network of mobile phone operator 102, which includes for example, base station 103. Similarly, for example, personal computer 110 (e.g., a laptop computer, tablet, desktop, smart television, workstation or the like) is connectable to the network provided by Internet service provider 104, which is ultimately connectable to communication network 106.

Communication network 106 may be any combination of wired and wireless local area network (LAN) and/or wide area network (WAN), such as an intranet and/or an extranet, including a portion of the Internet. It is sufficient that communication network 106 provide communication capability between client devices (e.g., smart phones 108 and personal computers 110) and servers. In some implementations, communication network 106 uses the HyperText Transport Protocol (HTTP) to transport information using the Transmission Control Protocol/Internet Protocol (TCP/IP). HTTP permits a client device to access various resources available via communication network 106. However, the various implementations described herein are not limited to the use of any particular protocol.

In this manner, smart phone 108 and personal computer 110 (collectively referred to as “client device 108/110”) are, in some circumstances, clients of server system 111-a and/or server system 111-b.

Those skilled in the art will appreciate from the present disclosure that any number of such devices and/or systems may be provided in a client-server environment, and particular devices may be altogether absent. In other words, client-server environment 100 is merely an example provided to discuss more pertinent features of the present disclosure.

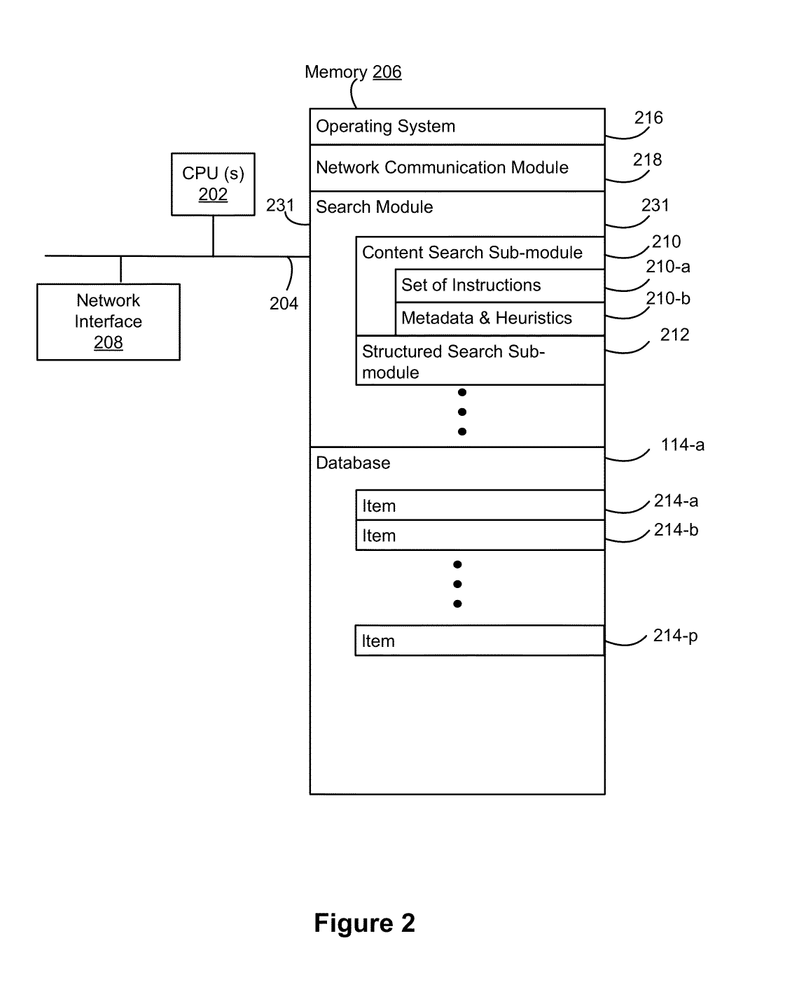

FIG. 2 is a block diagram illustrating an example of server system 111-a, discussed above with reference to FIG. 1, in accordance with some implementations. While certain specific features are illustrated, those skilled in the art will appreciate from the present disclosure that various other features have not been illustrated for the sake of brevity and so as not to obscure more pertinent aspects of the implementations disclosed herein. To that end, server system 111-a includes one or more processing units (CPUs) 202, one or more network or other communications interfaces 208, memory 206, and one or more communication buses 204 for interconnecting these and various other components. Communication buses 204 may include circuitry (sometimes called a chipset) that interconnects and controls communications between system components. Memory 206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from CPU(s) 202. Memory 206, including the non-volatile and volatile memory device(s) within memory 206, comprises a non-transitory computer readable storage medium.

In some implementations, memory 206 or the non-transitory computer readable storage medium of memory 206 stores the following programs, modules and data structures, or a subset thereof including operating system 216, network communication module 218, search module 231, and database 114.

Operating system 216 includes procedures for handling various basic system services and for performing hardware dependent tasks.

Network communication module 218 facilitates communication with other devices (e.g., other server systems 111 as well as client devices 108/110) via one or more network interfaces 208 (wired or wireless) and one or more communication networks, such as the Internet, other wide area networks, local area networks, metropolitan area networks, and so on.

Search module 231 is configured to receive, from a client, a partial search query (or a full search query) that includes one or more search terms. Search module 231 analyzes the one or more search terms of the partial search query to determine (e.g., generate) one or more auto-complete suggestions. Some of the auto-complete suggestions are content-based auto-complete suggestions. Some of the auto-complete suggestions include a predefined search operator chosen based on a result of the analysis of the one or more search terms of the partial search query, and are therefore structure-based auto-complete suggestions. Some auto-complete suggestions are a combination of content-based and structure-based. The search module 231 optionally includes separate sub-modules to handle the two types of searches: content search sub-module 210 (which includes a set of instructions 210-a and metadata and heuristics 210-b) executes content-based searches, or content-based portions of searches, for items 214 that match a search request; while structured search sub-module 212 executes structure-based searches, or structure-based portions of searches, for items 214 that match the search request (e.g., searches based on attributes, properties and/or metadata associated with items 214).

The search queries are directed toward items 214 stored in database 114-a. For example, database 114-a includes a plurality of items (e.g., item 214-a, item 214-b, through item 214-p). In some implementations, the items are emails (or a unique record of an email corresponding uniquely to a single recipient). In some implementations, the items include metadata that store properties and/or attributes against which structure-based searches are executed.

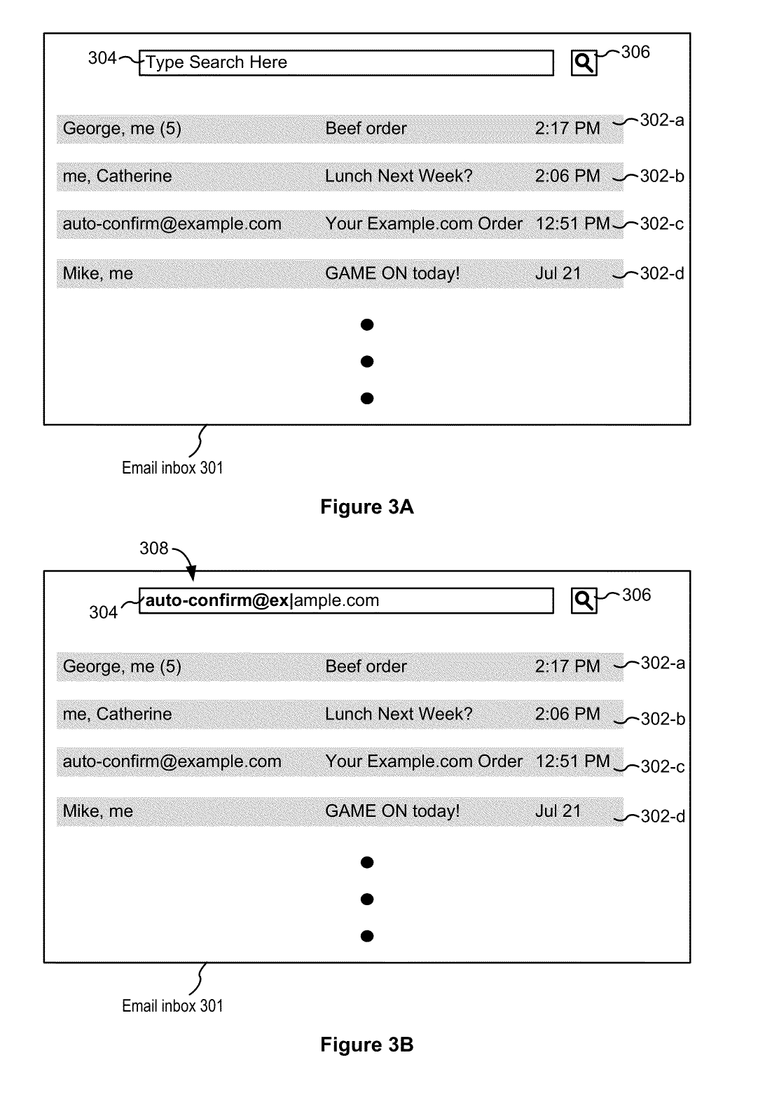

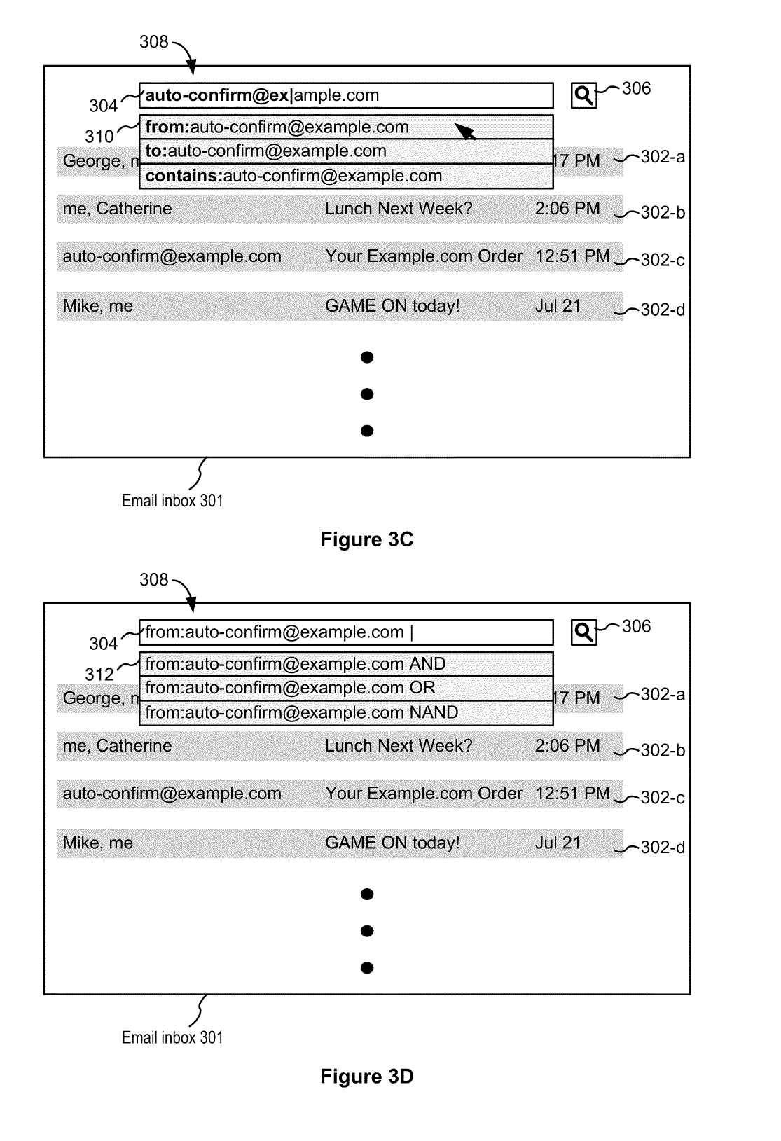

FIGS. 3A-3D illustrate examples of graphical user interfaces (GUIs) that provide auto-complete suggestions for structured search queries, in accordance with some implementations. For the sake of explanation, the graphical user interfaces shown in FIGS. 3A-3D are for searching a plurality of electronic documents. More specifically, the electronic documents in these examples are described as electronic mail documents (emails). In various implementations, the electronic documents are instant messaging conversations, text messaging conversations (e.g., using simple messaging service (SMS) or multimedia messaging service (MMS) messages) web pages, and/or database records, to name a few. In some implementations (for example, when the electronic documents are web pages), the electronic documents correspond to physical items (e.g., physical items offered for sale by an online vendor). Thus, in accordance with some embodiments, a user may use GUIs similar to those shown in FIGS. 3A-3D to search for a camera with particular specifications and/or features on an online vendor's website (e.g., rather than the webmail website shown in FIGS. 3A-3D). Such specifications (e.g., a camera with no fewer than 8 megapixels or for sale at a price lower than $500) are ideally suited for structured searches. Such GUIs assist the user in entering structured searches by providing auto-complete suggestions for the appropriate syntax structures.

FIG. 3A illustrates email inbox 301 (e.g., displayed on a display of a client device, such as client device 108/110, FIG. 1). Within email inbox 301 are a plurality of email messages (emails) 302 (e.g., email 302-a; 302-b; 302-c; and 302-d). In some circumstances, email inbox 301 corresponds uniquely to a user of the client device (e.g., the emails within email inbox 301 are the user's emails). Email inbox 301 also includes search bar 304 through which the user can enter textual search queries that include one or more search terms. Email inbox 301 also includes search button 306 for executing searches in accordance with the search query entered in search bar 304. A button is an example of an affordance, which more generally refers to any user interface element that provides a user with a manner through which to perform a task (e.g., such as executing a search). In various circumstances, these textual search queries can be either content-based (e.g., a user may search for particular words and/or phrases within his email), structure-based (e.g., meaning that the search query specifies one or more attributes and/or properties of the desired emails, such as an “unread” property), or a combination thereof (e.g., the user may request unread email messages having the word “baseball” in the message body and/or header).

FIG. 3B is analogous to FIG. 3A, except that the user has entered partial search query 308 in search bar 304. In this example, partial search query 308 consists of a single search term “auto-confirm@ex.” As shown in the example, the single search term is, in fact, a partial search term: the bold-faced text in search bar 304 left of the cursor (indicated by the character “I”) is text that has been entered by the user, whereas the un-bolded text to the right of the cursor is an auto-complete suggestion for the single (partial) search term (e.g., auto-confirm@example.com). In some implementations, the user can select a predefined affordance (e.g., a left-arrow button on the client device's keyboard) to accept the auto-complete suggestion. Alternatively (e.g., on a mobile client device such as a smart phone), the user can enter an input which is recognized by the device as acceptance of the auto-complete suggestion using a heuristic (e.g., the user shakes the device to accept the auto-complete suggestion). The auto-complete suggestion in FIG. 3B is a first type of auto-complete suggestion, namely an inline auto-complete suggestion that is provided in search bar 304. Further, as shown in FIG. 3B, in some implementations, the auto-complete suggestions are provided and displayed prior to execution of a search (e.g., by actuating search button 306).

FIG. 3C is analogous to FIG. 3B, except that FIG. 3C also illustrates a second type of auto-complete suggestion not shown in FIG. 3B. Namely, FIG. 3C illustrates that, in some implementations, one or more auto-complete suggestions are provided in drop down menu 310. In some implementations, a plurality of auto-complete suggestions is concurrently provided. In this example, drop down menu 310 includes a plurality (e.g., three) auto-complete suggestions that each include a respective predefined search operator (e.g., predefined search operators “from:”; “to:”; and “contains:”). In some implementations, executed search requests are sent to a server system (e.g., server system 111-a, FIG. 2) that stores and manages emails 302 (e.g., as items 214, FIG. 2). For example, in some implementations, the character string (e.g., text string) “from:” (without the quotation marks) is predefined by the server system such that the server system interprets a search request containing the string “from:” as a request for email messages from an email address specified by the text that follows the character string “from:”. To that end, if the auto-complete suggestion “from:auto-confirm@example.com” is selected and the search is executed by the user, the server system interprets the resulting search request as a request for emails within email inbox 301 that are from the email address “auto-confirm@example.com.”

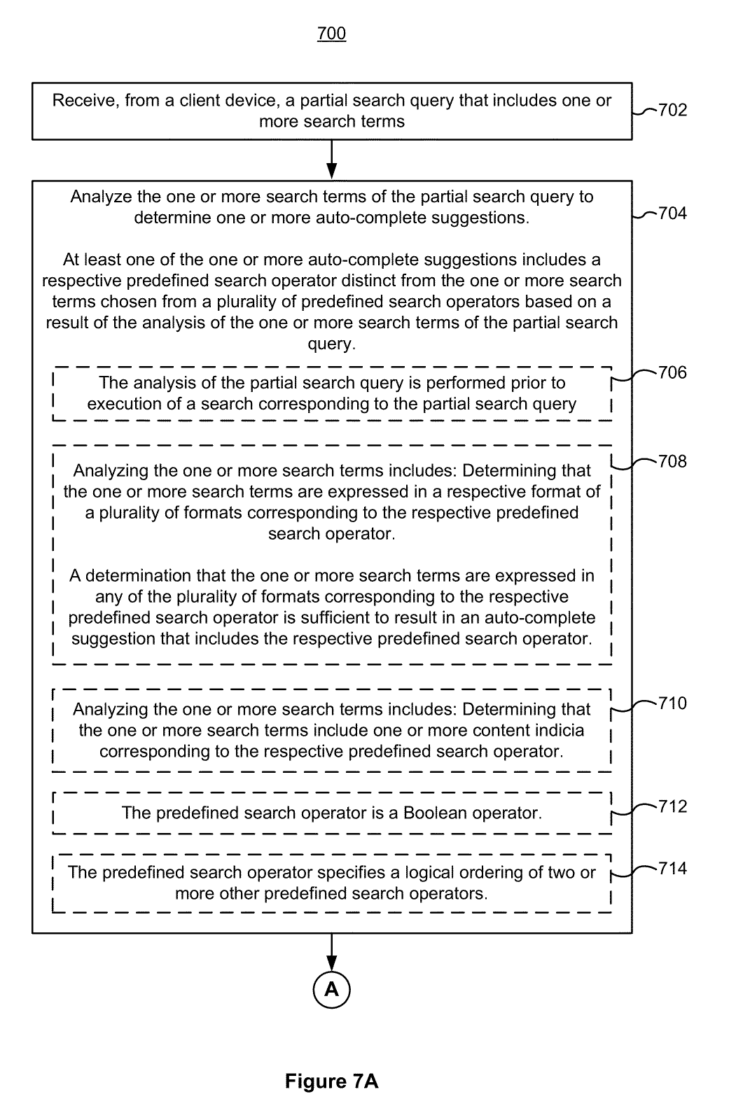

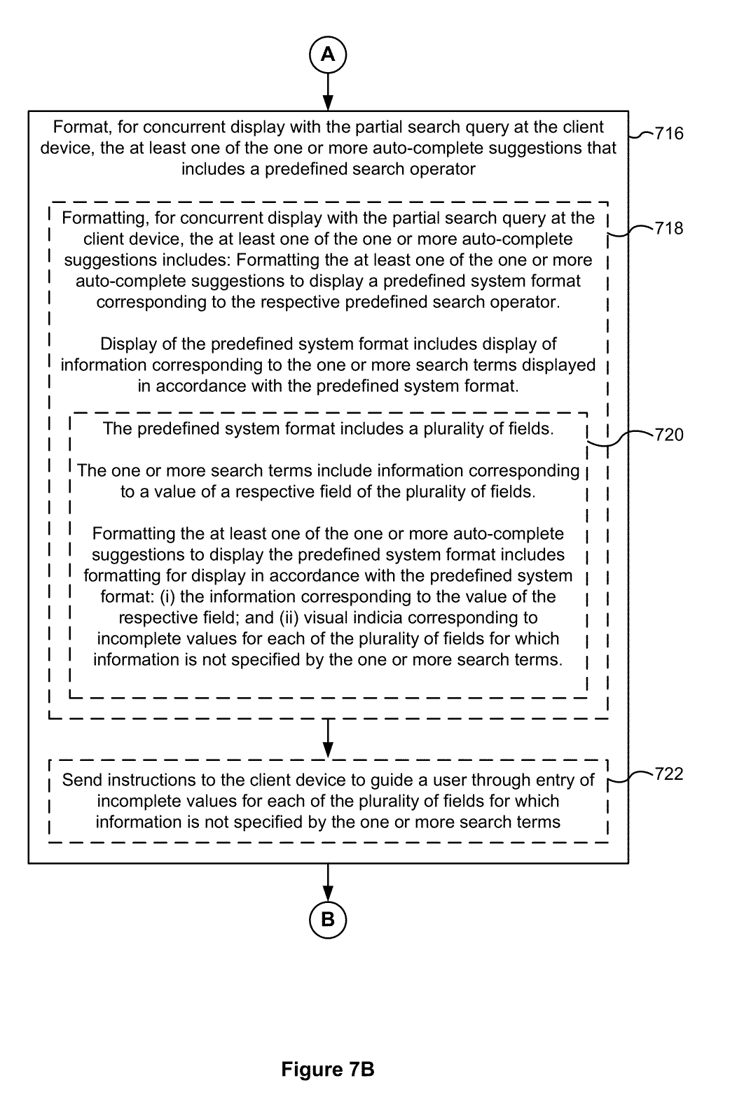

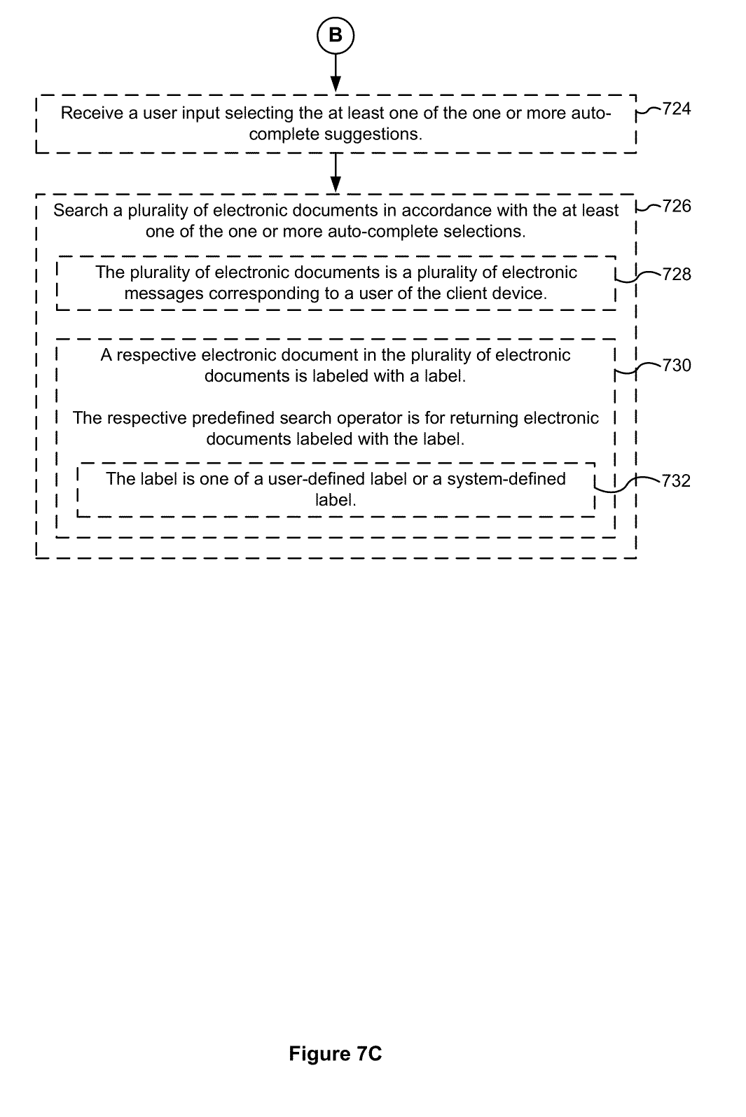

In some implementations, as explained in greater detail with reference to method 700 (FIGS. 7A-7C), the incomplete search queries (also called “partial search queries”) are sent to the server system (e.g., at predefined synchronization intervals, such as 0.1 seconds, or whenever the search query changes). The server system then analyzes the one or more search terms of the search query to determine which predefined search operators are appropriate for auto-complete suggestions. For example, the server system analyzes partial search query 308 and determines that the lone search term complies with a format given by: (i) a first character string; followed by (ii) an “@” symbol; followed by (iii) a second character string. This format indicates that the search term is a potential email address, and thus the server system provides email-address-related auto-complete suggestions (e.g., predefined search operators “from:”; “to:”) as well as, optionally, a more general predefined search operator (e.g., predefined search operator “contains:” which indicates a request to search email bodies and/or email headers for the subsequent search terms). To this end, in some implementations, the server system performs a format analysis (or a semantic analysis, pattern analysis, etc.) to determine if a search term matches a predefined system format.

FIG. 3D is analogous to FIG. 3C, except that in FIG. 3D it is assumed, for the sake of continuing the current example, that the user has selected the auto-complete suggestion “from:auto-confirm@example.com” using the GUI shown in FIG. 3C. Consequently, the GUI shown in FIG. 3D displays updated drop down auto-complete suggestions 312, each of which includes the predefined search operator selected from the auto-complete suggestions in FIG. 3C (to wit, “from:”). In addition, updated drop down auto-complete suggestions 312 also display potential additional predefined search operators that are, in some circumstances, combined with the predefined search operator “from:”. These predefined search operators are Boolean operators “AND”; “OR”; and “NAND”; alerting the user to the various ways that she could further refine her search query.

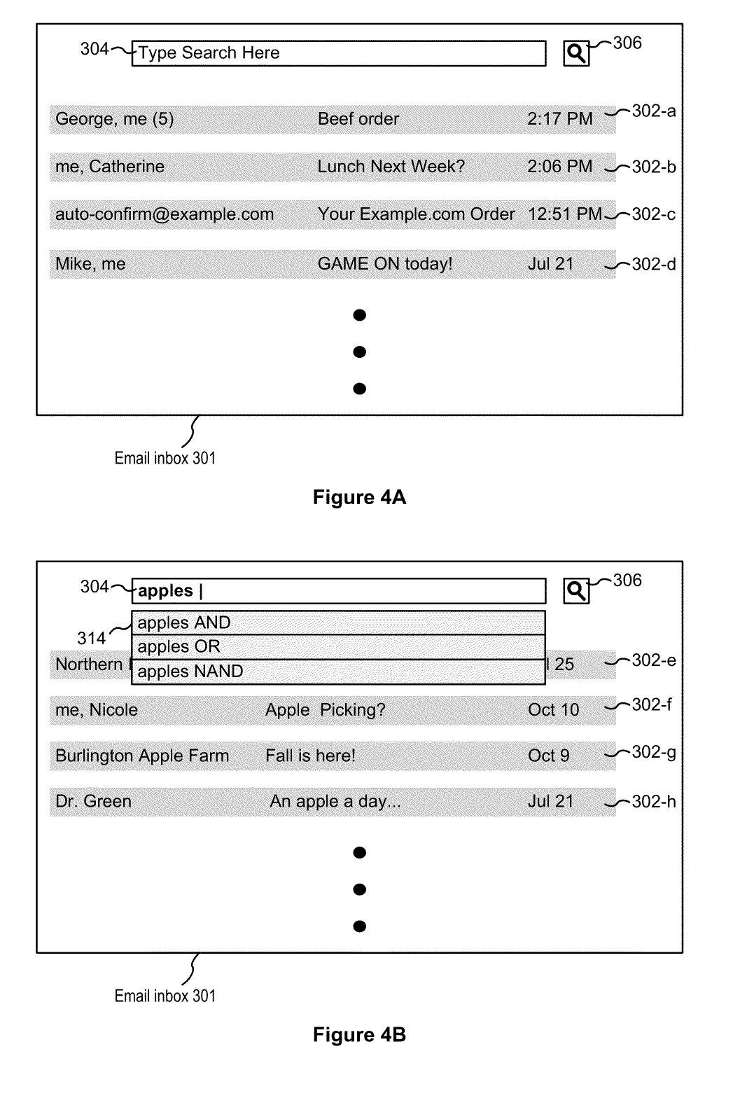

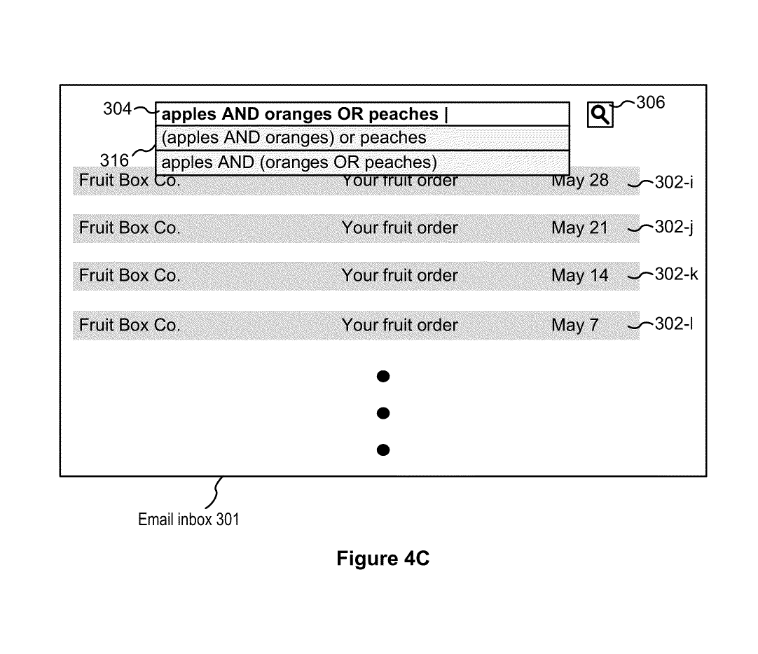

FIGS. 4A-4C illustrate additional examples of graphical user interfaces (GUIs) that provide auto-complete suggestions for structured search queries, in accordance with some implementations. For the sake of explanation, the graphical user interfaces shown in FIGS. 4A-4C are for searching a plurality of electronic documents. More specifically, the electronic documents in these examples are described as electronic mail documents (emails). In various implementations, the electronic documents are instant messaging conversations, text messaging conversations (e.g., using simple messaging service (SMS) or multimedia messaging service (MMS) messages) web pages, and/or database records, to name a few. Moreover, FIGS. 4A-4C share many features with FIGS. 3A-3D that have already been discussed. For brevity, only the differences between FIGS. 4A-4C and FIGS. 3A-3D are described further.

FIG. 4A is analogous to FIG. 3A. FIG. 4B, which follows graphically from FIG. 4A, however, illustrates implementations in which search results are automatically updated in real-time (or quasi-real-time) as the user enters a search query (comprising one or more search terms) into search bar 304. For example, in some implementations, when the user enters a new character in (or deletes a character from) search bar 304, the client device sends the server system an updated search query, and the server system responds with updated search results (e.g., update emails 302-e; 302-f; 302-g; and 302-h). In some implementations, the update is performed only when the user edits the search query in one of a group of special, predefined, ways (e.g., such as entering a space, signifying termination of a search term, or by deleting a previously entered search term). In some implementations, the update is performed periodically (e.g., once per second). In some implementations, auto-complete suggestions 314 include predefined search operators that are Boolean operators. In such circumstances, update is forgone upon entry of a Boolean operator (e.g., “AND”; “OR”; or “NAND”) into the search query, because, in some circumstances, a Boolean operator is meaningless until two arguments are specified (e.g., “apples AND” is logically meaningless whereas “apples AND oranges” is logically meaningful). Thus, in some embodiments, the update is performed upon entry of the word “apples”, the update is skipped upon entry of the word “AND” (e.g., by selection of an auto-complete suggestion), and the update is once again performed upon entry of the word “oranges.”

FIG. 4C illustrates some implementations in which auto-complete suggestions 316 include predefined search operators that specify a logical ordering of two or more other predefined search operators (e.g., the Boolean operators shown in FIG. 4B). For example, a user might enter a search query “apples AND oranges OR peaches” without considering the ambiguity of the order of operations. Stated another way, while a precise computer code might know how to handle such a query (e.g., the computer might be instructed to handle the logical operations from left to right), in many circumstances, a user would likely appreciate a reminder that they may have intended a different order of logical operations. To that end, auto-complete suggestions 316 include some or all of the possible orders of operation, as designated by parentheses indicating a logical ordering of the two Boolean operators (i.e., “AND” and “OR”) included in the search query (e.g., a set of parentheses is a predefined search operator specifying a logical ordering of two or more other predefined search operators). In accordance with the automatic (e.g., without user intervention) update of search results described with reference to FIG. 4B, updated search results are shown based on the search query entered into search bar 304 (e.g., emails 302-i; 302-j; 302-k; and 302-l). In some implementations, as the user scrolls over the auto-complete suggestions 316, the search results are updated in accordance with the cursor position (e.g., updated in accordance with a respective search corresponding to an auto-complete suggestion when the cursor is over the auto-complete suggestion).

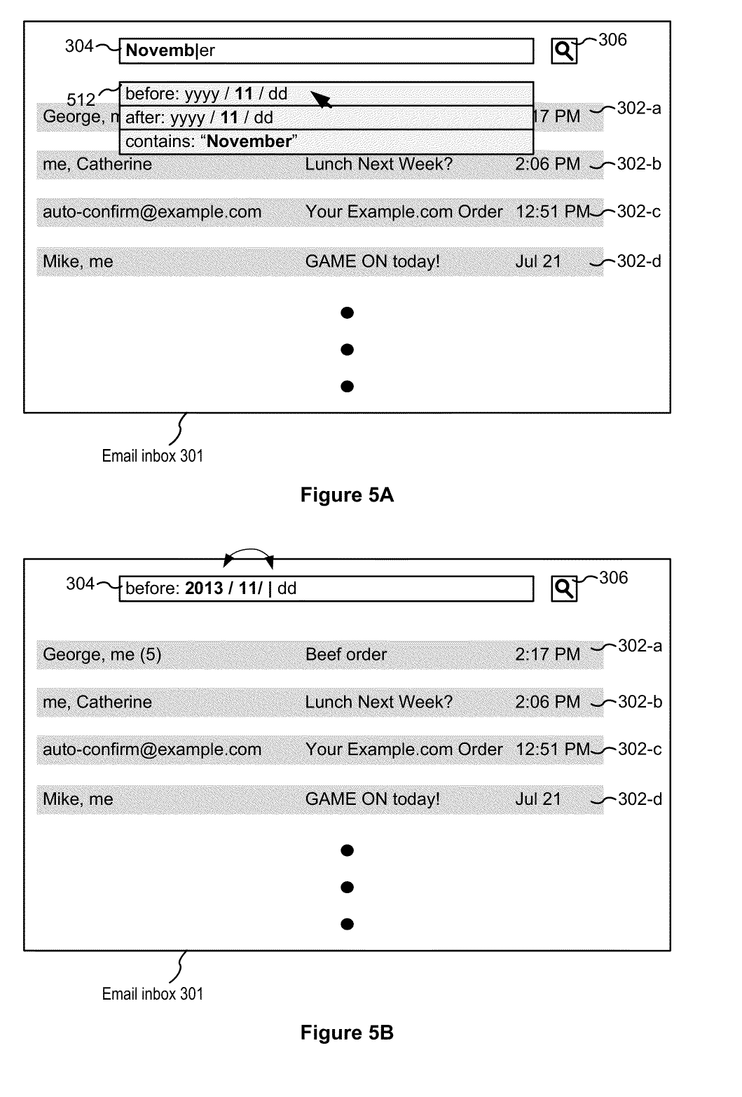

FIGS. 5A-5B illustrate additional examples of graphical user interfaces (GUIs) that provide auto-complete suggestions for structured search queries, in accordance with some implementations. For the sake of explanation, the graphical user interfaces shown in FIGS. 5A-5B are for searching a plurality of electronic documents. More specifically, the electronic documents in these examples are described as electronic mail documents (emails). In various implementations, the electronic documents are instant messaging conversations, text messaging conversations (e.g., using simple messaging service (SMS) or multimedia messaging service (MMS) messages) web pages, and/or database records, to name a few. Moreover, FIGS. 5A-5B share many features with FIGS. 3A-3D that have already been discussed. For brevity, only the differences between FIGS. 5A-5B and FIGS. 3A-3D are described further.

In FIG. 5A, the user has entered a partial search query “Novem.” The GUI illustrates that a content-based auto-complete suggestion (“November”) has been displayed in search bar 304. Also displayed in drop down menu 512 are several structure-based auto-complete suggestions with predefined search operators. In particular, the structure-based auto-complete suggestions are based on the content-based auto-complete suggestion, or, stated another way, in some implementations, the suggested predefined search operators are based on a result of a content-based auto-complete suggestion that has not yet been accepted by the user. More generally, in some implementations, the structure-based auto-complete suggestions are based on a determination that the one or more search terms in the search query include one or more content indicia corresponding to the respective predefined search operator. For example, in some implementations, names of months, or partial names of months, provide sufficient cause for the GUI to present time-and-date-related predefined search operators (e.g., “before:”; or “after:”).

In addition, certain predefined search operators expect arguments that are entered in a predefined system format (e.g., that includes one or more fields, each holding a value for an argument). For example, consider a time-and-date-related predefined search operator (e.g., “before:”). In some circumstances, a computer system might be configured to recognize dates in a format given by mm/dd/yyyy or, alternatively, a format given by dd/mm/yyyy. It is clearly important for the user to know which format is expected by the computer system. To that end, FIG. 5A also shows that, in some implementations, a predefined system format is displayed corresponding to the respective predefined search operator shown in an auto-complete suggestion. Display of the predefined system format includes display of information corresponding to the one or more search terms displayed in accordance with the predefined system format; that is to say, since “Novem” has been entered as a search term, the month (“11”) has been filled into the predefined system format for the “before:” auto-complete suggestion. Fields in the predefined system format that have not yet been entered (such as day and year) are, in some implementations, indicated as wildcard characters (e.g., “yyyy” and/or “dd”; signifying that year and day arguments are expected by, or are at least optional arguments for, the predefined search operator “from:”).

As shown in FIG. 5B, in some implementations, when a respective auto-complete suggestion is selected (e.g., from drop down menu 512), the graphical user interface guides the user through entry of incomplete values for each of the predefined system format's fields that were not entered in the original search query. For example, while “Novem” was auto-completed to “November” and corresponding information was entered in the auto-complete suggestion (e.g., the “11” was entered in place of “mm”), no information in FIG. 5A has been entered corresponding to the year and/or day arguments (e.g., values). To remedy this, in some implementations, the GUI positions the cursor at the wildcards for a first incomplete field (e.g., “yyyy”) and allows the user to type over the wildcards. The result is shown in FIG. 5B which illustrates that the user has overtyped “yyyy” with “2013.” When the user completes a field, the GUI jumps the cursor to the next incomplete field (e.g., the “dd” field in FIG. 5B) so as not to require the user to re-type the month value or click forward to move past it. In some implementations, entered fields (e.g., fields that have either been directly entered by the user or inferred from a content-based auto-complete suggestion) are visually distinguished from incomplete fields (e.g., by displaying entered fields in a bold-faced font).

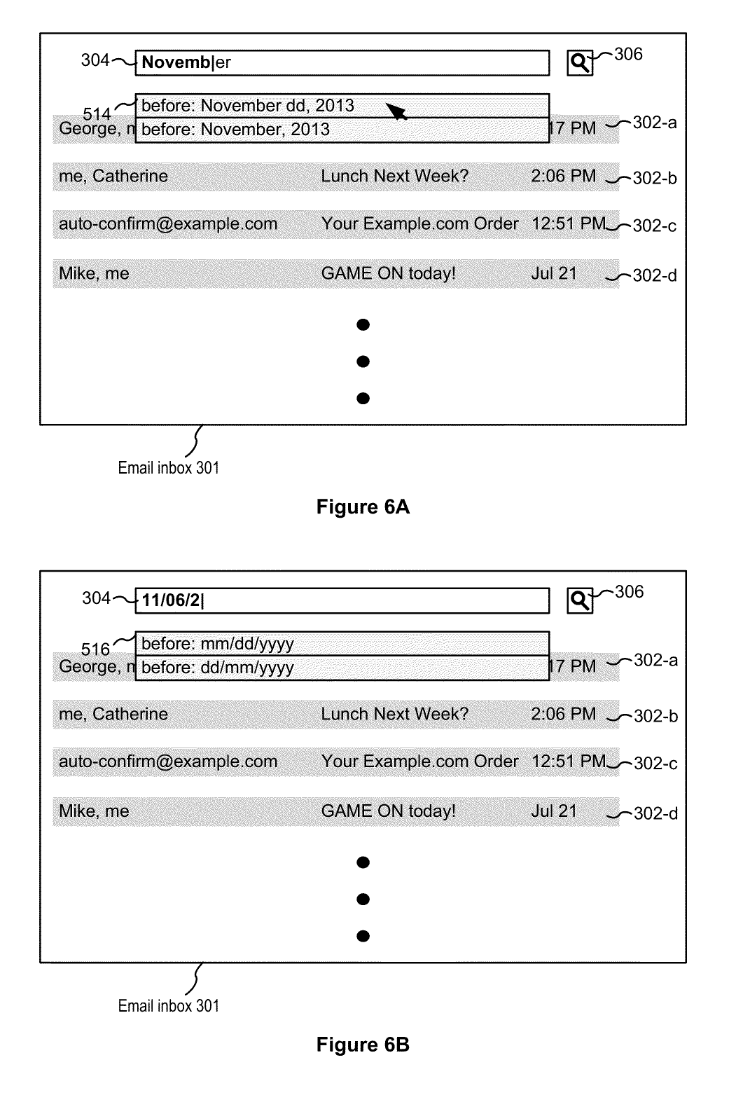

FIGS. 6A-6B illustrate additional examples of graphical user interfaces (GUIs) that provide auto-complete suggestions for structured search queries, in accordance with some implementations. For the sake of explanation, the graphical user interfaces shown in FIGS. 6A-6B are for searching a plurality of electronic documents. More specifically, the electronic documents in these examples are described as electronic mail documents (emails). In various implementations, the electronic documents are instant messaging conversations, text messaging conversations (e.g., using simple messaging service (SMS) or multimedia messaging service (MMS) messages) web pages, and/or database records, to name a few. Moreover, FIGS. 6A-6B share many features with FIGS. 3A-3D that have already been discussed. For brevity, only the differences between FIGS. 6A-6B and FIGS. 3A-3D are described further.

FIG. 6A illustrates the same GUI as FIG. 6B. Together, FIGS. 6A-6B are intended to demonstrate that, in some implementations, a respective predefined search operator will accept arguments in a plurality of distinct predefined system formats, so long as the computer system (e.g., the server system) can unambiguously determine which predefined system format is being used. For example, in FIG. 6A, the user has entered “Novemb” for which a content-based auto-complete suggestion “November” is provided. Based on the content-based auto-complete suggestion, the server system determines that the user is attempting to enter a date. The server system then provides structure-based auto-complete suggestions relating to dates (e.g., including the predefined search operator “before:”) and also provides a format for entering the remaining arguments. Moreover, the format provided for entering the remaining argument is chosen so as to be consistent with what the user has already entered. For example, because the user has already entered “Novemb,” the user is likely comfortable entering the remaining fields in a format exemplified by “Nov. 6, 2013.” However, when the user has entered “11/06/2,” in some implementations, the server system assumes that the user is more comfortable entering a date in the format exemplified by “11/06/2013” and provides auto-complete suggestions in accordance with that format. But since “11/06/2013” could be either “Nov. 6, 2013” or “Jun. 11, 2013,” in some implementations, the server system provides auto-complete suggestions for both formats. Selection of one of the formats causes information to be stored (e.g., on the server system) indicating which format is in use.

FIGS. 7A-7C illustrate a flowchart of method 700 for providing auto-complete suggestions to structured searches, in accordance with some implementations. In particular, some implementations of method 700 recognize when a user is attempting to enter an attribute of desired search results and aide the user by directing he or she to complete a structured search query that accords with, for example, a proper syntax. Thus, users who are unaccustomed to precise syntaxes or users who simply have difficulty remembering syntax options are greatly assisted in entering structured search queries.

In some implementations, method 700 is performed at a server system (e.g., server system 111-a, FIG. 1). In some implementations, various operations performed with reference to method 700 can be distributed across multiple servers or multiple server systems. For example, in some implementations, some operations performed with reference to method 700 are performed at server system 111-a while others are performed at server system 111-b (both shown in FIG. 1). For ease of explanation, method 700 is described with reference to a single server system. Also, in some implementations, operations shown in separate figures may be combined to form other methods, and operations shown in the same figure and/or discussed in association with the same method may be separated into different methods.

A server system receives (702), from a client device, a partial search query that includes one or more search terms. In some implementations, the partial search query is received from a messaging application or a messaging website. For example, in some implementations, the messaging application is an email application and/or the messaging website is a webmail website. In some implementations, the partial search query is received from the client device by way of another server system. For example, in some circumstances, a webmail server system receives a partial search query corresponding to a search for email messages and directs the partial search query to the server system, which (in this example) is a search server system. In some implementations, a search term is a word. In some implementations, the one or more search terms are separated by a special character or a sequence of characters (e.g., a space or a predefined search operator, as explained below). For example, when a partial search query includes the character string “Vidalia Onions,” in some implementations, “Vidalia” and “Onions” are each considered a respective search term because they are separated by a space.

The server system analyzes (704) the one or more search terms of the partial search query to determine one or more auto-complete suggestions. At least one of the one or more auto-complete suggestions includes a respective predefined search operator distinct from the one or more search terms chosen from a plurality of predefined search operators based on a result of the analysis of the one or more search terms of the partial search query. Stated another way, in some implementations, the server system analyzes the one or more search terms of the partial search query to determine which of the plurality of predefined search operators are appropriate for auto-complete suggestions. In some implementations, the predefined search operators define a property (sometimes called an attribute) of the desired search results. Often, the value of the attribute is specified as an argument of the predefined search operator.

Consider an example in which the partial search query is for searching for emails. In some implementations, the predefined search operator “from:” signifies that a character string to the right of the predefined search operator (e.g., the argument of the predefined search operator) specifies an email address from which desired search results were sent (e.g., an attribute value of the attribute “from”).

Various examples of auto-complete suggestions that include predefined search operators that are distinct from the one or more search terms are shown in, and discussed with reference to, the GUI figures of the present disclosure, namely: FIGS. 3A-3D, FIGS. 4A-4C, FIGS. 5A-5B, and FIGS. 6A-6B. In some implementations, the auto-complete suggestions are updated search queries. An auto-complete suggestion that includes a predefined search operator is known as a structure-based auto-complete suggestion. An auto-complete suggestion that includes updated content (e.g., “Novemb” to “November” as shown in FIG. 5A) is known as a content-based auto-complete suggestion. Some auto-complete suggestions are a combination of content-based and structure-based auto-complete suggestions.

In addition, the auto-complete suggestions are, in accordance with a variety of implementations, provided in a number of different manners. For example, in some implementations, auto-complete suggestions are provided as inline auto-complete suggestions (see search query bar 304, FIG. 3B, and corresponding description). In some implementations, auto-complete suggestions are provided in a drop down menu. In some implementations, auto-complete suggestions are provided as GUI buttons (or other affordances) that appear near a search bar as the search query is entered. For example, if a user types in “auto-confirm@example.com” to search bar 304 (FIG. 3C), in some implementations, buttons for “TO” and “FROM” appear just below search bar 304.

In some implementations, the analysis of the partial search query is performed (706) prior to execution of a search corresponding to the partial search query. As used herein, in some implementations, the term partial search query is intended to mean that the user has not yet executed the search. Alternatively, in some implementations, method 700 is operable to receive an executed search query rather than a partial search query. In some implementations, the client device sends partial search queries to the server system at predefined synchronization intervals, such as 0.1 seconds, or whenever the search query changes.

In some implementations, analyzing the one or more search terms includes (708): Determining that the one or more search terms are expressed in a respective format of a plurality of formats corresponding to the respective predefined search operator. A determination that the one or more search terms are expressed in any of the plurality of formats corresponding to the respective predefined search operator is sufficient to result in an auto-complete suggestion that includes the respective predefined search operator.

As one example, as shown in FIGS. 3A-3D, the server system analyzes partial search query 308 and determines that the lone search term complies with a format given by: (i) a first character string; followed by (ii) an “@” symbol; followed by (iii) a second character string. In some implementations, the last four characters of the character string are one of the group consisting of “.com”; “.org.”; “.edu”, or any other predefined email suffix, and thus the format is actually a plurality of formats. This format indicates that the search term is a potential email address, and thus the server system provides email-address-related auto-complete suggestions (e.g., predefined search operators “from:”; “to:”) as well as, optionally, a more general predefined search operator (e.g., predefined search operator “contains:” which indicates a request to search email bodies and/or email headers for the subsequent search terms). To this end, in some implementations, the server system performs a format analysis (or a semantic analysis, pattern analysis, etc.) to determine if a search term matches a predefined system format.

As another example, as shown in FIGS. 6A-6B, in some implementations, the server system recognizes a plurality of predefined system formats corresponding to dates. Therefore, when a user begins to enter a search query in one of the date system formats, the server system provides auto-complete suggestions with date-and-time-related predefined search operators (e.g., “before:”; “after:”).

In some implementations, analyzing the one or more search terms includes (710): Determining that the one or more search terms include one or more content indicia corresponding to the respective predefined search operator. For example, as shown in FIGS. 6A-6B, in some implementations, names of months, or partial names of months, provide sufficient cause for the GUI to present time-and-date-related predefined search operators (e.g., “before:”; or “after”). In some implementations, the content indicia are character strings and a predefined search operator includes a set of character strings that map to the predefined search operator.

In some implementations, the predefined search operator is (712) a Boolean operator. A Boolean operator is an operator that takes two arguments, each identifiable as “true” or “false,” and returns a result of “true” or “false.” As such, in some circumstances, the arguments taken by a Boolean operator may themselves include another predefined system operator and its argument, for example: “from:example1@example.com AND to:example2@example.com.” However, in some implementations, when a predefined search operator is not specified in one or more of a Boolean operator's arguments, a default predefined search operator is assumed. For example, as shown in FIGS. 4A-4C, the search query “apples AND oranges” includes an argument “apples” that is the implied argument of a predefined search operator “includes:”, meaning that the server system is to search for emails that include the term “apples” in the message body and/or header (likewise for “oranges”). Stated another way, the same search term could be equivalently rewritten “includes:apples AND includes:oranges.”

In some implementations, the predefined search operator specifies (714) a logical ordering of two or more other predefined search operators. For example, as shown in FIGS. 4A-4C, parentheses indicate the desired order through which a plurality of Boolean operators is to be executed in the search.

The server system formats (716), for concurrent display with the partial search query at the client device, the at least one of the one or more auto-complete suggestions that includes a predefined search operator. In some implementations, concurrent display of the at least one of the one or more auto-complete suggestions with the partial search query includes providing the at least one of the one or more auto-complete suggestions for display in real-time (e.g., without delay) while the user of the client device is entering the search query.

In some implementations, formatting, for concurrent display with the partial search query at the client device, the at least one of the one or more auto-complete suggestions includes (718): Formatting the at least one of the one or more auto-complete suggestions to display a predefined system format corresponding to the respective predefined search operator. Display of the predefined system format includes display of information corresponding to the one or more search terms displayed in accordance with the predefined system format. For example, consider a time-and-date-related predefined search operator (e.g., “before:”). In some circumstances, the server system might be configured to recognize dates in a format given by mm/dd/yyyy or, alternatively, a format given by dd/mm/yyyy. It is clearly important for the user of the client device to know which format is expected by the server system. As shown in FIGS. 5A-5B, in some implementations, a predefined system format is displayed corresponding to the respective predefined search operator shown in an auto-complete suggestion. Display of the predefined system format includes display of information corresponding to the one or more search terms displayed in accordance with the predefined system format; that is to say, since “Novem” has been entered as a search term, the month (“11”) has been filled into the predefined system format for the “before:” auto-complete suggestion. Fields in the predefined system format that have not yet been entered (such as day and year) are, in some implementations, indicated as wildcard characters (e.g., “yyyy” and/or “dd”; signifying that year and day arguments are expected by, or are at least optional arguments for, the predefined search operator “from:”).

In some implementations, the predefined system format includes (720) a plurality of fields (e.g., a date system format includes a “day” field, a “month” field, and a “year” field). The one or more search terms include information corresponding to a value of a respective field of the plurality of fields. Formatting the at least one of the one or more auto-complete suggestions to display the predefined system format includes formatting for display in accordance with the predefined system format: (i) the information corresponding to the value of the respective field; and (ii) visual indicia corresponding to incomplete values for each of the plurality of fields for which information is not specified by the one or more search terms. For example, as shown in FIG. 5B, since “Novem” has been entered as a search term, the month (“11”) has been filled into the predefined system format for the “before:” auto-complete suggestion. Fields in the predefined system format that have not yet been entered (such as day and year) are, in some implementations, indicated as wildcard characters (e.g., “yyyy” and/or “dd”; signifying that year and day arguments are expected by, or are at least optional arguments for, the predefined search operator “from:”).

In some implementations, the server system sends (722) instructions to the client device to guide a user through entry of incomplete values for each of the plurality of fields for which information is not specified by the one or more search terms. Returning to the example shown in FIG. 5A, while “Novem” was auto-completed to “November” and corresponding information was entered in the auto-complete suggestion (e.g., the “11” was entered in place of “mm”), no information has been entered corresponding to the year and day arguments (e.g., values). To remedy this, in some implementations, the server system sends instructions to the client device to position the cursor at the wildcards for a first incomplete field (e.g., “yyyy”) and allows the user to type over the wildcards. When the user completes the first field, the GUI jumps the cursor to the next incomplete field (e.g., the “dd” field in FIG. 5B) so as not to require the user to re-type the month value or click forward to move past it.

In some implementations, the server system receives (724) a user input selecting the at least one of the one or more auto-complete suggestions. The server system then searches (726) a plurality of electronic documents in accordance with the at least one of the one or more auto-complete selections. In some implementations, the plurality of electronic documents is (728) a plurality of electronic messages corresponding to a user of the client device. For example, in some implementations, the electronic messages are the user's emails. To that end, in some implementations, the electronic documents correspond uniquely to a common recipient (e.g., the user). For example, as shown in FIG. 2, each item 214 represents a record of an email message (or other type of communication) that corresponds uniquely to the user.

In some implementations, a respective electronic document in the plurality of electronic documents is labeled (730) with a label. The respective predefined search operator is for returning electronic documents labeled with the label. For example, in some implementations, a user can annotate (using a GUI) email messages or conversation with particular user-defined labels. In some implementations, the server system automatically, without user intervention, applies system-defined labels (e.g., such as “unread”; “inbox”; “important” labels).

The foregoing description, for the purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

It will be understood that, although the terms “first,” “second,” etc. may be used herein to describe various elements, these elements should not be limited by these terms. These terms are only used to distinguish one element from another. For example, a first item could be termed a second item, and, similarly, a second item could be termed a first item, without changing the meaning of the description, so long as all occurrences of the “first item” are renamed consistently and all occurrences of the “second item” are renamed consistently. The first item and the items are both items, but they are not the same item.

The terminology used herein is for the purpose of describing particular implementations only and is not intended to be limiting of the claims. As used in the description of the implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “upon a determination that” or “in response to determining” or “in accordance with a determination” or “upon detecting” or “in response to detecting” that the stated condition precedent is true, depending on the context.

What is claimed is:

1. A method, comprising:
at a server system that includes one or more processors and memory:
receiving, from a client device, a partial search query that includes one or more search terms;
analyzing the one or more search terms of the partial search query to determine one or more auto-complete suggestions, wherein at least one of the one or more auto-complete suggestions includes a respective predefined search operator distinct from the one or more search terms chosen from a plurality of predefined search operators based on a result of the analysis of the one or more search terms of the partial search query; and
formatting, for concurrent display with the partial search query at the client device, the at least one of the one or more auto-complete suggestions that includes a predefined search operator.

2. The method of claim 1, wherein the analysis of the partial search query is performed prior to execution of a search corresponding to the partial search query.

3. The method of claim 1, wherein analyzing the one or more search terms includes:
determining that the one or more search terms are expressed in a respective format of a plurality of formats corresponding to the respective predefined search operator, wherein a determination that the one or more search terms are expressed in any of the plurality of formats corresponding to the respective predefined search operator is sufficient to result in an auto-complete suggestion that includes the respective predefined search operator.

4. The method of claim 3, wherein analyzing the one or more search terms includes:
determining that the one or more search terms include one or more content indicia corresponding to the respective predefined search operator.

5. The method of claim 3, wherein formatting, for concurrent display with the partial search query at the client device, the at least one of the one or more auto-complete suggestions includes:
formatting the at least one of the one or more auto-complete suggestions to display a predefined system format corresponding to the respective predefined search operator, wherein display of the predefined system format includes display of information corresponding to the one or more search terms displayed in accordance with the predefined system format.

6. The method of claim 5, wherein:
the predefined system format includes a plurality of fields;
the one or more search terms include information corresponding to a value of a respective field of the plurality of fields; and
formatting the at least one of the one or more auto-complete suggestions to display the predefined system format includes formatting for display in accordance with the predefined system format:
the information corresponding to the value of the respective field; and
visual indicia corresponding to incomplete values for each of the plurality of fields for which information is not specified by the one or more search terms.

7. The method of claim 6, further including:
sending instructions to the client device to guide a user through entry of incomplete values for each of the plurality of fields for which information is not specified by the one or more search terms.

8. The method of claim 1, further comprising:
receiving a user input selecting the at least one of the one or more auto-complete suggestions; and
searching a plurality of electronic documents in accordance with the at least one of the one or more auto-complete suggestions.

9. The method of claim 8, wherein the plurality of electronic documents is a plurality of electronic messages corresponding to a user of the client device.

10. The method of claim 8, wherein:
a respective electronic document in the plurality of electronic documents is labeled with a label; and
the respective predefined search operator is for returning electronic documents labeled with the label.

11. The method of claim 10, wherein the label is one of a user-defined label or a system-defined label.

12. The method of claim 1, wherein the predefined search operator is a Boolean operator.

13. The method of claim 1, wherein the predefined search operator specifies a logical ordering of two or more other predefined search operators.

14. A computing system, comprising:
one or more processors;
memory; and
one or more programs, wherein the one or more programs are stored in the memory and are configured to be executed by the one or more processors, the one or more programs including instructions for:
receiving, from a client device, a partial search query that includes one or more search terms;
analyzing the one or more search terms of the partial search query to determine one or more auto-complete suggestions, wherein at least one of the one or more auto-complete suggestions includes a respective predefined search operator distinct from the one or more search terms chosen from a plurality of predefined search operators based on a result of the analysis of the one or more search terms of the partial search query; and
formatting, for concurrent display with the partial search query at the client device, the at least one of the one or more auto-complete suggestions that includes a predefined search operator.

15. The computing system of claim 14, wherein the analysis of the partial search query is performed prior to execution of a search corresponding to the partial search query.

16. The computing system of claim 14, wherein the instructions for analyzing the one or more search terms include instructions for:
determining that the one or more search terms are expressed in a respective format of a plurality of formats corresponding to the respective predefined search operator, wherein a determination that the one or more search terms are expressed in any of the plurality of formats corresponding to the respective predefined search operator is sufficient to result in an auto-complete suggestion that includes the respective predefined search operator.

17. The computing system of claim 16, wherein the instructions for analyzing the one or more search terms include instructions for:
determining that the one or more search terms include one or more content indicia corresponding to the respective predefined search operator.

18. The computing system of claim 16, wherein the instructions for formatting, for concurrent display with the partial search query at the client device, the at least one of the one or more auto-complete suggestions include instructions for:
formatting the at least one of the one or more auto-complete suggestions to display a predefined system format corresponding to the respective predefined search operator, wherein display of the predefined system format includes display of information corresponding to the one or more search terms displayed in accordance with the predefined system format.

19. The computing system of claim 18, wherein:
the predefined system format includes a plurality of fields;
the one or more search terms include information corresponding to a value of a respective field of the plurality of fields; and
formatting the at least one of the one or more auto-complete suggestions to display the predefined system format includes formatting for display in accordance with the predefined system format:
the information corresponding to the value of the respective field; and
visual indicia corresponding to incomplete values for each of the plurality of fields for which information is not specified by the one or more search terms.

20. A non-transitory computer readable storage medium storing one or more programs, the one or more programs comprising instructions, which when executed by a computing system with one or more processors cause the computing system to:
receive, from a client device, a partial search query that includes one or more search terms;
analyze the one or more search terms of the partial search query to determine one or more auto-complete suggestions, wherein at least one of the one or more auto-complete suggestions includes a respective predefined search operator distinct from the one or more search terms chosen from a plurality of predefined search operators based on a result of the analysis of the one or more search terms of the partial search query; and
format, for concurrent display with the partial search query at the client device, the at least one of the one or more auto-complete suggestions that includes a predefined search operator.
